(19) United States
(12) Patent Application Publication
(10) Pub. No.: US 2014/0085899 A1
(43) Pub. Date: Mar. 27, 2014

(54) LED LUMINAIRE

(71) Applicant: TOSHIBA LIGHTING & TECHNOLOGY CORPORATION, Kanagawa (JP)

(72) Inventors: Takeshi HISAYASU, Kanagawa (JP); Hikaru TERASAKI, Kanagawa (JP)

(21) Appl. No.: 13/790,275

(22) Filed: Mar. 8, 2013

(30) Foreign Application Priority Data
Sep. 25, 2012 (JP) 2012-211387

(51) Int. Cl. F21K 99/00; F21V 9/16

(52) U.S. Cl. CPC F21K 9/50; F21V 9/16
USPC 362/260

(57) ABSTRACT

According to one embodiment, an LED luminaire includes a housing, an LED module mounted on one end of the housing, and a resin member configured to cover a peripheral portion of the LED module and fix the LED module to the housing. A wavelength conversion member, which is a cover member coupled to a peripheral portion of the resin member at an opening end thereof and covering the LED module, and including a wavelength conversion material on the surface or in the interior thereof, and a globe configured to cover the wavelength conversion member are also provided

### CROSS-REFERENCE TO RELATED APPLICATIONS

This application is based upon and claims the benefit of priority from the prior Japanese Patent Application No. 2012-211387, filed on Sep. 25, 2012, the entire contents of which are incorporated herein by reference.

### FIELD

Embodiments described herein relate generally to a luminaire using LEDs as a light source.

### BACKGROUND

In the related art, an LED lamp provided with a phosphor apart from LEDs when obtaining white light by letting blue light from the LEDs pass through a yellow phosphor is proposed.

For example, by applying the yellow phosphor on a globe of a light bulb and covering the LEDs, light radiated from the LEDs may be converted into the white light and go out to the outside through the yellow phosphor. There is also an example in which another globe is provided on the outside of the globe on which the yellow phosphor is applied.

In light bulbs in which a wavelength conversion phosphor is provided apart from LEDs, LED lamps capable of being manufactured by a method with a higher working efficiency and having a good quality of conformance in light-emitting characteristics from the standpoint of appearance are desired.

### DESCRIPTION OF THE DRAWINGS

FIG. 1 is a perspective view for explaining an LED luminaire according to a first embodiment;

FIG. 2 is an appearance view for explaining the luminaire;

FIG. 3 is a vertical cross-sectional view of the luminaire taken along a lamp center axis when observed from the side;

FIG. 4 is a partial enlarged view for explaining the luminaire;

FIG. 5 is an exploded perspective view for explaining a modification of a module fixing member; and

FIG. 6 is an exploded perspective view for explaining another modification of the member.

### DETAILED DESCRIPTION

In view of the above circumstances, there is provided an LED luminaire which achieves a superior manufacturing efficiency specifically for retrofit lamps.

An LED luminaire according to an embodiment includes a housing, an LED module mounted on one end of the housing, and a resin member configured to cover a peripheral portion of the LED module and fix the LED module to the housing. A cover member coupled at an opened end thereof to a peripheral portion of the resin member and configured to cover the LED module, which is a wavelength conversion member provided with a wavelength conversion material on the surface or in the interior thereof, and a globe configured to cover the wavelength conversion member are also provided.

According to the embodiments, an LED luminaire having a small number of components, capable of separating the wavelength conversion member and the globe, and achieves a superior manufacturing efficiency, natural light-emitting characteristics, and high conversion efficiency may be provided.

Referring now to the drawings, an embodiment will be described below.

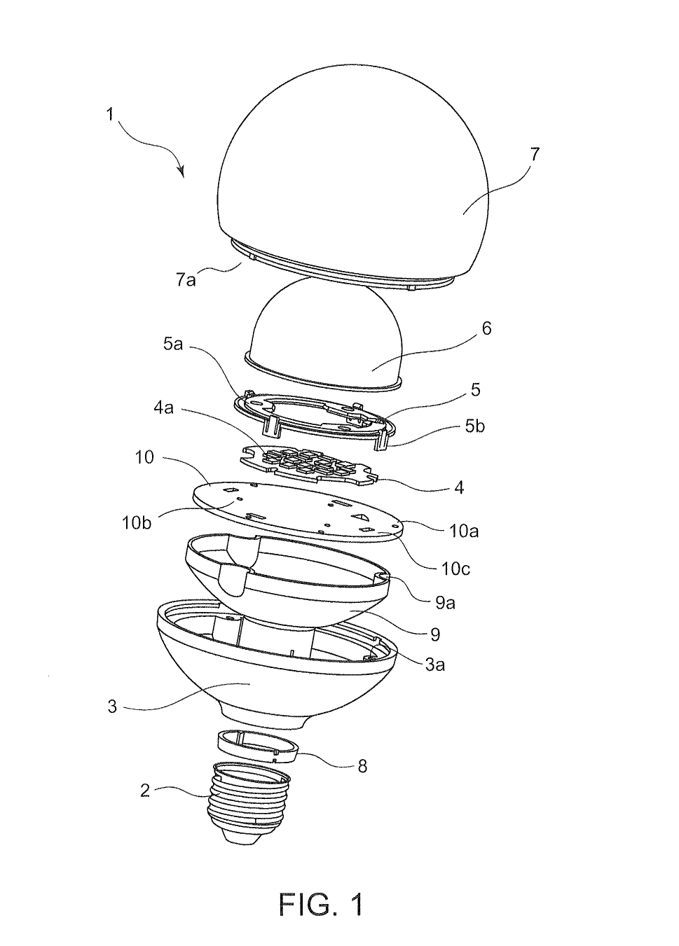

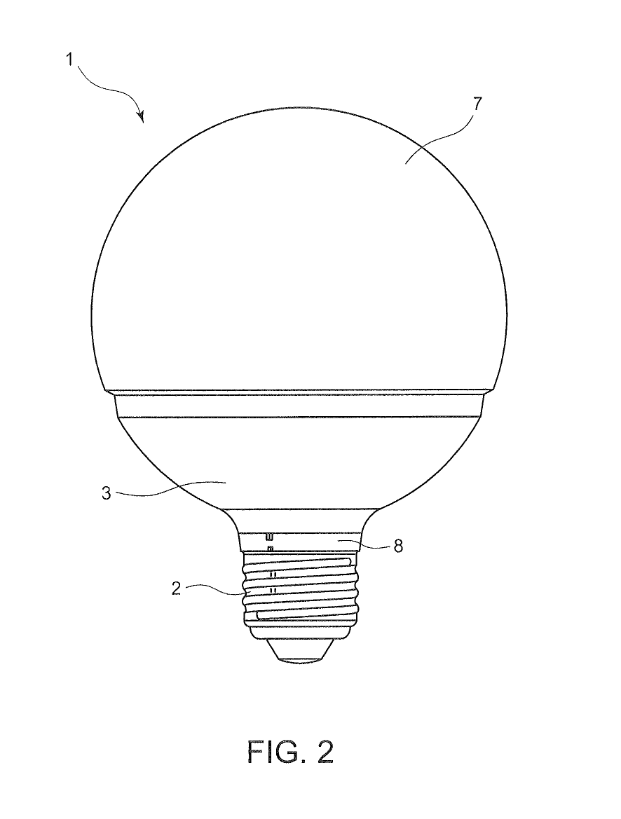

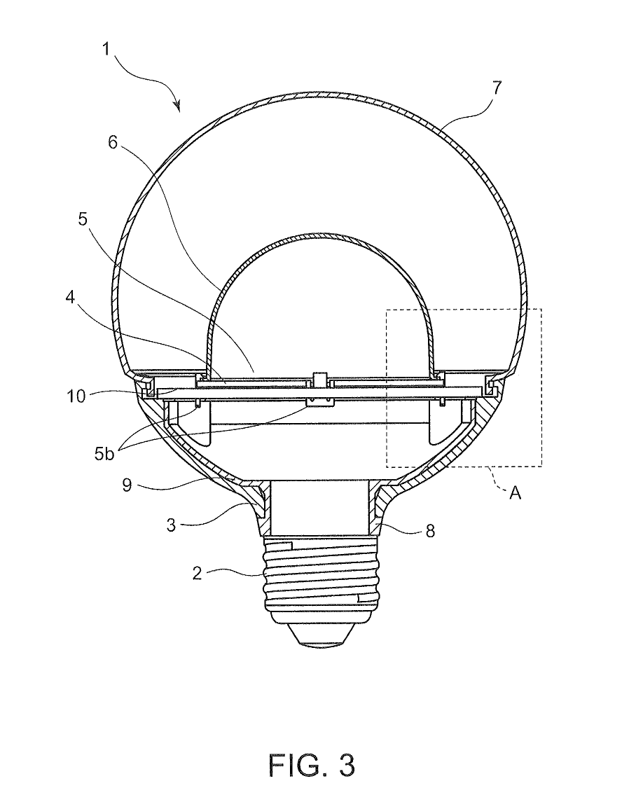

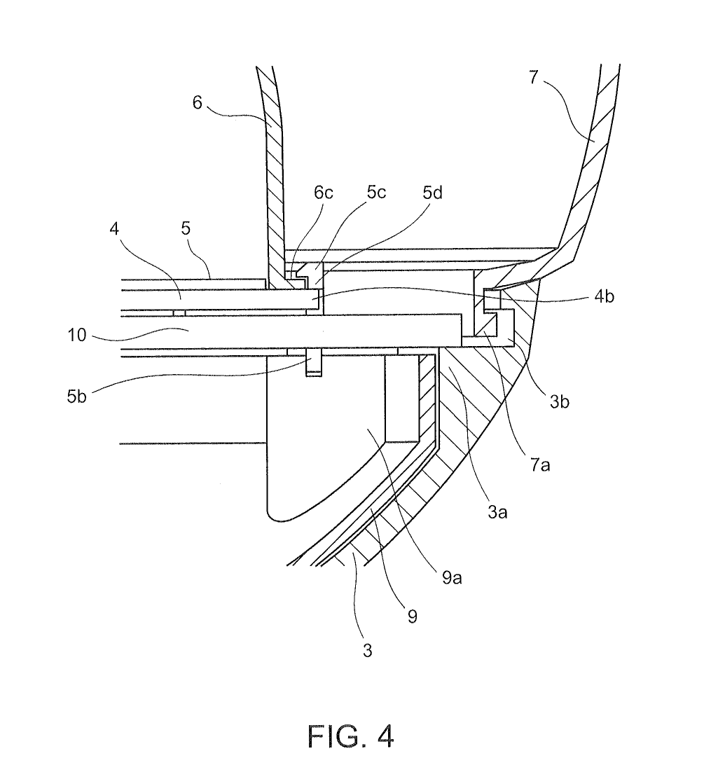

FIG. 1 is a perspective view for explaining an LED luminaire according to a first embodiment. FIG. 1 illustrates an LED lamp 1 as an example of the LED luminaire. In FIG. 1, a state in which components are separated from each other in the direction of an axis of a light valve in order to allow easy understanding of the structure is illustrated. FIG. 2 illustrates an appearance view of the LED lamp in a state in which respective components in FIG. 1 are coupled to each other. FIG. 3 is a vertical cross-sectional view of the lamp taken along a center axis thereof viewed from the side. FIG. 4 is a partial enlarged view of FIG. 3.

Referring now to FIG. 1, respective components will be described. The LED lamp 1 includes a housing 3 having a cap 2 connected to one end thereof, an LED module 4 installed at the other end of the housing 3 in a state of being capable of conducting heat to the housing 3, a module fixing member 5 configured to fix the LED module 4 to the housing 3, a wavelength conversion member 6 configured to cover the LED module 4 and fixed to the module fixing member 5, and a globe 7 configured to cover the wavelength conversion member 6.

The cap 2 as a power receiving portion from an external power source is screwed to an end of an insulating cylinder 9. The cap 2 and the housing 3 are coupled by the cap 2 and the insulating cylinder 9 holding a bottom portion of the housing 3 when being screwed. When the housing 3 is formed of a metal, an insulating ring 8 is preferably interposed between the housing 3 and the cap 2 for insulation. When provision of insulation between the cap 2 and the housing 3 is not necessary because the housing 3 has properties of insulator or the like, the insulating ring 8 may be omitted. The cap 2 may be selected from a variety of types in addition to an illustrated E-cap according to application.

The housing 3 is preferably capable of receiving heat generated by the LED module 4 and radiating the heat to the outside. The housing having thermal radiation properties as described above is provided by a metallic housing formed through metal die-casting or metal pressing. When constraints relating to thermal radiation are not severe, a housing formed of a resin material having high thermal conductivity may be used. The shape of the housing 3 is a cylindrical shape, and preferably has a small diameter at one end thereof so as to continue to the diameter of the cap 2 which conforms the standard, and a larger diameter at the other end on which the LED module 4 is to be mounted than the diameter on the cap side because the globe 7 is installed thereon.

The insulating cylinder 9 is provided in the interior of the housing 3, and a lighting circuit (not illustrated) is placed in the interior of the insulating cylinder 9. A screw portion of the cap 2 of the insulating cylinder 9 has a diameter smaller than that of the housing 3, and protrudes downward through a hole formed on the bottom portion of the housing 3. The insulating cylinder 9 has a diameter sufficient for accommodating the lighting circuit. The lighting circuit is electrically connected by wires (not illustrated) at one end thereof to the cap and at the other end thereof to the LED module 4, respectively. When the housing 3 has properties of insulator, the lighting circuit may be accommodated in the housing 3 without using the insulating cylinder 9.

A metallic radiator plate 10, which is a metallic thermal radiation plate called as heat sink, is provided on an end portion of the housing 3 on the side where the LED module 4 is mounted. The radiator plate 10 is a plate configured to support the LED module 4, and conduct heat generated by the LED module 4 to the housing 3.

Coupling between the radiator plate 10 and the housing 3 is achieved by the following method, for example. A projection 3a projecting in the lamp-axis direction is formed on an inner side surface of the housing 3, and a depression 9a is formed on the insulating cylinder 9 at a position matching the projection 3a. By fitting the projection 3a and the depression 9a, the relative rotation between the housing 3 and the insulating cylinder 9 may be prevented. A screw hole is formed on an upper surface of the projection 3a. The radiator plate 10 is connected to the housing 3 by a screw screwed into the screw hole of the projection 3a through a screw insertion hole 10a of the radiator plate 10. In the embodiment, the housing 3 and the radiator plate 10 are configured as separate members. However, the both members maybe formed in one body. In such a case, connection between the radiator plate 10 and the housing 3 using the screw as described above is not necessary.

The LED module 4 is installed on the radiator plate 10 in a state of being capable of conducting heat to the radiator plate 10. The state of being capable of conducting heat means that preferably the both members are in contact to each other directly or indirectly over a wider plane. In order to enable thermal conduction from the LED module 4 to the radiator plate 10 while securing the insulating properties between the LED module 4 and the radiator plate 10, a thermal conductive insulating sheet is preferably inserted between the LED module 4 and the radiator plate 10.

The LED module 4 includes one or more LED elements 4a arrayed on a module substrate in a interconnected state by wires, and is lit by power supplied from the lighting circuit. The LED module 4 is not formed with a phosphor, and hence light from the LED elements 4a is emitted as-is from the LED module 4 without being subject to a wavelength conversion.

Fixation of the LED module 4 to the radiator plate 10 is performed by using the module fixing member 5. The module fixing member 5 is formed with a shoulder which covers a peripheral end portion of the LED module 4 from above, and is formed with screw insertion holes 5a. Screw holes 10b are formed on the radiator plate 10 at positions aligned with the screw insertion holes 5a. The LED module 4 may be fixed to the radiator plate 10 by using the module fixing member 5 by screwing screws into the screw holes 10b via the screw insertion holes 5a. In FIG. 1, the screw insertion holes 5a and the screw holes 10b are formed equidistantly (120°) at three points. However, the number and the positions are not limited thereto.

In order to further ensure the fixation of the LED module 4 to the radiator plate 10/housing 3, the fixation using screws described above is preferable. However, if the fixation using screws is difficult or fixation using screws is not necessary, fixation with other devices is also applicable. For example, fixation by bonding the LED module 4 to the radiator plate 10/housing 3, then providing the module fixing member 5 with engaging claws with respect to the radiator plate 10/housing 3, and fitting the engaging claws of the module fixing member into engaging holes formed on the radiator plate 10/housing 3 is also possible.

In FIG. 1, the shape of the module fixing member 5 is a complete annular shape extending along the entire peripheral portion of the LED module 4. However, the shape of the module fixing member 5 is not limited thereto, and any size and shape may be employed as long as the fixation of the LED module 4 is achieved. For example, a ring shape partly missing (opened) may be employed for the module fixing member 5. The ring shape is not limited to a circle, and may be a polygonal shape such as square, pentagon, and hexagon.

In FIG. 1, claws 5b for positioning are formed at four positions on a peripheral side portion of the module fixing member 5. The claws 5b face holes 10c of the radiator plate 10, and may be used for positioning when coupling the module fixing member 5 with the radiator plate 10. By this positioning, working efficiency at the time of manufacture may be improved.

The module fixing member 5 is preferably covered with an insulating material at least on the surface thereof in order to secure a creeping distance from the LED module 4 to the metallic radiator plate 10/housing 3. The entire portion may be formed of an insulative resin material. The material of the module fixing member 5 preferably has rigidity required of fixation. For example, the module fixing member 5, the claws 5b and 5c, and a shoulder 5d may be formed of a resin material such as polycarbonate.

The wavelength conversion member 6 configured to cover the LED module 4 is coupled to the peripheral end portion of the module fixing member 5. A coupling structure will be described later with reference to FIG. 4. The wavelength conversion member 6 is formed of a resin or the like having light permeability (transparent or translucent), namely, light transmitting capability. Resin-made inner and outer walls are applied with a wavelength conversion material such as a phosphor for converting the wavelength upon reception of light emitted from the LED module 4. Alternatively, the wavelength conversion material is mixed in the resin which forms the wavelength conversion member 6. By selecting a variety of the wavelength conversion materials, adjustment of light outgoing from the wavelength conversion member 6 upon reception of light from the LED elements 4a is achieved as needed.

The shape of the wavelength conversion member 6 is a semi-spherical dome shape in FIG. 1. However, a variety of shapes such as a cylindrical shape or a polygonal pyramid may be employed. However, in order to distribute light outgoing therefrom uniformly, the shape of the wavelength conversion member 6 is preferably a rotational symmetry with respect to the lamp axis, that is, a semi-spherical shape or a spherical shape.

The globe 7 has light permeability and may have a semi-spherical shape or a cylindrical shape. Preferably, the globe 7 is formed of a light permeable resin, namely, light transmitting resin, and a translucent material or a structure which diffuses light from the wavelength conversion member 6 is employed. In order to make the globe 7 translucent, there are several methods such as applying a translucent material on an inner wall or an outer wall of the globe 7, forming a film thereon, or kneading a material to make materials translucent. The structure for diffusing light includes a method of providing concavities and convexity on an inner surface or an outer surface thereof.

Enhancement of diffusion of heat generated by the LED module 4 is important to improve the efficiency of the LED lamp. In the embodiment, since the globe 7 which further covers the wavelength conversion member 6 which covers the LED module 4 is formed, lowering of the thermal radiation efficiency may be resulted. In addition, the wavelength conversion member 6 also generates heat caused by wavelength conversion. In view of such circumstances, a ventilation hole communicating with the interior and the exterior is preferably provided on the globe 7. However, since the provision of such a hole may cause entry of dust from the exterior, a dustproof filter is preferably provided on the ventilation hole.

By providing the globe 7 and the wavelength conversion member 6 separately as in the embodiment, the wavelength conversion member 6 may be reduced in size. In this configuration, the wavelength may be converted by a less amount of wavelength conversion material than a case where a wavelength conversion function is added to the globe 7. The wavelength conversion member 6 is colored because the phosphor is included. However, by the intermediary of the translucent globe 7, the appearance of the LED lamp 1 is alleviated in color of the wavelength conversion member 6, so that natural color is produced.

In the embodiment, two members, that is, the LED module 4 and the wavelength conversion member 6 may be fixed to the housing 3 by the module fixing member 5. Therefore, the fixation of the LED module 4 and the wavelength conversion member 6 to the housing 3 is ensured with a small number of components without causing cost increases. The fixation of the LED module 4 to the housing 3 may be performed indirectly when the radiator plate 10 is provided therebetween, and directly when the radiator plate 10 is formed with the housing 3 as one body.

With the provision of the wavelength conversion member 6 in an optical path from the LED module 4 to the globe 7, a boundary where light passes through is increased, and hence light loss may be increased. Therefore, at least the surface of the module fixing member 5 on the side of the wavelength conversion member 6 is provided with light reflectivity. Accordingly, light returning from the inner surface of the wavelength conversion member 6 to the module fixing member 5 side may be reflected, and hence the light loss maybe reduced.

For example, by using a resin material such as white polycarbonate for the module fixing member 5, the module fixing member 5 may be provided with the light reflectivity. Alternatively, the module fixing member 5 may be provided with the light reflectivity by applying a light-reflective material on a main body of the module fixing member 5 or by coating a main body portion with a light-reflective film. However, using the light-reflective material for the module fixing member 5 by itself may eliminate a process of application or coating, so that the light loss may be reduced without making a manufacturing process complicated.

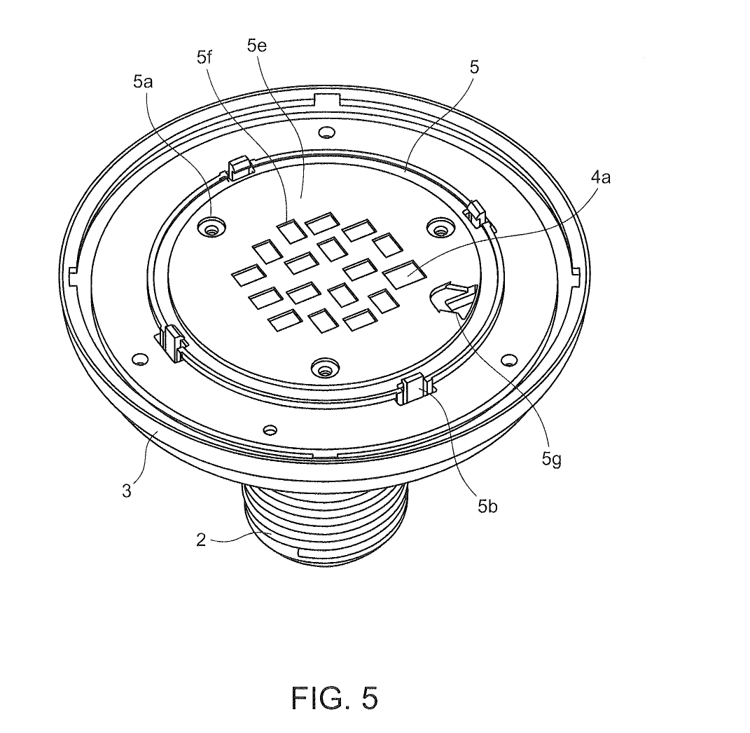

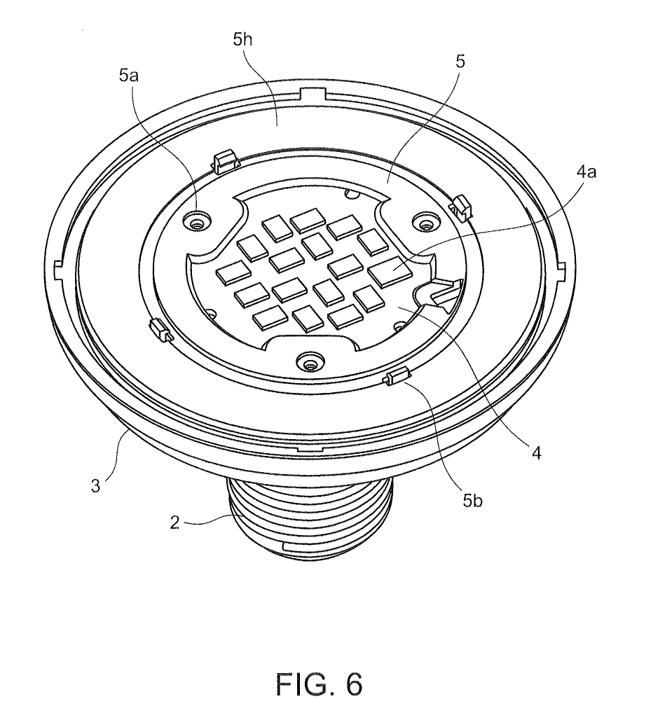

In the same manner, the surface of the LED module 4 or the surface of the radiator plate 10 on the globe 7 side are preferably provided with the light reflectivity. The structure will be described later with reference to FIG. 5 and FIG. 6.

FIG. 2 is a side view after the assembly of the respective components of the LED lamp according to the first embodiment. In FIG. 2, a case where a translucent material is used for the globe 7 is assumed, and the outline of the wavelength conversion member 6 cannot be viewed. clearly from the appearance. The visibility of the outline of the wavelength conversion member 6 from the appearance is increased as the globe 7 get closer to transparent.

FIG. 3 is a cross-sectional view of a complete LED lamp according to the first embodiment taken along a vertical plane passing through the center of the lamp axis and viewed from the side. FIG. 4 is an enlarged view of a part A surrounded by a broken line in FIG. 3.

An outer peripheral portion 3a of the housing 3 on the side where the LED module is to be mounted is formed with a shelf for placing the radiator plate 10, and a peripheral portion of the radiator plate 10 is placed on this shelf. In the embodiment, the coupling between the housing 3 and the radiator plate 10 is achieved by using the screws as described above.

The globe 7 and the housing 3 may be engaged by fitting a coupling claw 7a of the globe 7 into an engaging groove 3b formed on an outer peripheral end portion of the housing 3. The coupling claw 7a and the engaging groove 3b may be formed continuously into an annular shape, or may be formed partly thereon.

Assembly of the housing 3 and the globe 7 is not limited to the above-described configuration. For example, an adhesive agent may be used instead of using the claw and the groove as described above. In contrast, a configuration in which the relationship between the claw and the groove is inverted, that is, the claw is formed on the housing 3 and the groove is formed on the globe 7 to cause the both to engage is also applicable. Other various modifications may also be applied.

A peripheral end portion 4b of the LED module 4 is in surface contact with the shoulder 5d provided on the LED module 4 side of the module fixing member 5. In this state, the LED module 4 may be pressure-contacted to the radiator plate 10 by locking the module fixing member 5 to the radiator plate 10 by the screws as described above.

Furthermore, the claws 5c are formed at a side end portion of the module fixing member 5 to allow the wavelength conversion member 6 to be engaged with the module fixing member 5 by deflecting the wavelength conversion member 6 and fitting an extending portion 6c formed at a lower end of the wavelength conversion member 6 under the claws 5c. Since the module fixing member 5 is already connected to the housing 3 by the fixation to the radiator plate 10, the wavelength conversion member 6 may be mounted on the housing 3 by engaging the wavelength conversion member 6 with the module fixing member 5.

The extending portion 6c is formed radially outward at the lower end on the opening side of the semi-spherical wavelength conversion member 6. The extending portion 6c has a width sufficient for being inserted under the claws 5c so as not come apart therefrom.

The coupling of the LED module 4/wavelength conversion member 6 with the radiator plate 10 by the module fixing member 5 is not limited to the configuration described above. For example, the coupling between the LED module 4 and the peripheral edge portion of the module fixing member 5 is achieved by using the adhesive agent without using the shoulder 5d as described above. The coupling between the LED module 4 and the peripheral edge portion of the module fixing member 5 is also achieved by providing claws extending radially outward on the module fixing member 5 and extending portions extending radially inward at the lower end of an opening portion of the wavelength conversion member 6, and engaging the claws and the extending portions. Other various modifications may also be applied.

An inner portion of the module fixing member 5 located inside the wavelength conversion member 6 and an outer ring portion of the module fixing member 5 having the claws 5c, the shoulder 5d, and the claws 5b for positioning and located on the outside of the wavelength conversion member 6 maybe formed separately. However, depending on the requirement, the both members may be formed in one body so as to continue under the extending portion 6c of the wavelength conversion member 6.

FIG. 5 is an exploded perspective view illustrating a modification of the module fixing member 5. In this modification, the light reflective module fixing member 5 is extended to a position on the LED module 4. Specifically, the module fixing member 5 is formed into a plate shape as illustrated by reference sign 5e to cover the LED module 4, and the plate 5e is formed with windows 5f to expose the LED elements 4a. The windows 5f are through holes penetrating from a lower surface to an upper surface of the module fixing member 5, and hence the light emitted from the LED elements 4a may be introduced out. A window 5g at a connector portion where the line from the lighting circuit is connected is also formed. In this manner, by extending the light reflective module fixing member 5 to a portion other than the LED elements 4a of the LED module 4 or the connector, the light loss on the surface of the LED module 4 may be reduced.

FIG. 6 is an exploded perspective view illustrating another modification of the module fixing member 5. In this modification, the module fixing member 5 is extended to an area 5h of the radiator plate 10 where the LED module 4 is not formed. In this manner, by extending the light reflective module fixing member 5 to the area 5h of the radiator plate 10 where the LED module 4 is not formed, the light loss on the surface of the radiator plate 10 may be reduced. By using a combination of the embodiments illustrated in FIG. 5 and FIG. 6, the light reflectivity may be provided from the LED module 4 to the radiator plate 10 by a single plate-shaped module fixing member 5.

While certain embodiments have been described, these embodiments have been presented by way of example only, and are not intended to limit the scope of the inventions. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An LED luminaire comprising:
a housing;
an LED module mounted on one end of the housing;
a resin member configured to cover a peripheral portion of the LED module and fix the LED module to the housing;
a wavelength conversion member, which is a cover member coupled to a peripheral portion of the resin member at an opening end thereof and covering the LED module, and including a wavelength conversion material on the surface or in the interior thereof; and
a globe configured to cover the wavelength conversion member.

2. The luminaire according to claim 1, wherein the surface of the resin member facing the wavelength conversion member is provided with light reflectivity.

3. The luminaire according to claim 1, wherein the resin member is provided with a shoulder configured to hold a peripheral end portion of a substrate of the LED module on the surface thereof on the LED module side, and the LED module is fixed to the housing via the resin member by the resin member fixed to the housing.

4. The luminaire according to claim 1, comprising a radiation plate provided between the housing and the LED module.

5. The luminaire according to claim 4, wherein a claw for positioning is provided on a lower surface of the resin member, and a hole is provided on the surface of the radiation plate corresponding to the claw for positioning.

6. The luminaire according to claim 1, wherein the resin member is provided with a claw, the wavelength conversion member is provided with an extending portion at a lower end thereof, and the wavelength conversion member is fixed by the engagement between the claw and the extending portion.

7. The luminaire according to claim 2, wherein the resin member extends on the upper surface of the LED module and the surface of the resin member of an extending portion is provided with the light reflectivity, and is formed with a plurality of windows corresponding to LEDs.

8. The luminaire according to claim 2, wherein the resin member extends on the periphery of the LED module and the surface of the resin member of an extending portion is provided with the light reflectivity.

9. An LED luminaire comprising:
a housing;
an LED module mounted on one end of the housing;
a radiation plate provided between the housing and the LED module;
a resin member configured to cover a peripheral portion of the LED module and fix the LED module to the housing;
a wavelength conversion member, which is a cover member coupled to a peripheral portion of the resin member at an opening end thereof and covering the LED module, and including a wavelength conversion material on the surface or in the interior thereof; and
a globe configured to cover the wavelength conversion member.

10. The luminaire according to claim 9, wherein the surface of the resin member facing the wavelength conversion member is provided with light reflectivity.

11. The luminaire according to claim 9, wherein the resin member is provided with a shoulder configured to hold a peripheral end portion of a substrate of the LED module on the surface thereof on the LED module side, and the LED module is fixed to the housing via the resin member by the resin member fixed to the housing.

12. The luminaire according to claim 9, wherein a claw for positioning is provided on a lower surface of the resin member, and a hole is provided on the surface of the radiation plate corresponding to the claw for positioning.

13. The luminaire according to claim 9, wherein the resin member is provided with a claw, the wavelength conversion member is provided with an extending portion at a lower end thereof, and the wavelength conversion member is fixed by the engagement between the claw and the extending portion.

14. The luminaire according to claim 10, wherein the resin member extends on the upper surface of the LED module and the surface of the resin member of an extending portion is provided with the light reflectivity, and is formed with a plurality of windows corresponding to LEDs.

15. The luminaire according to claim 10, wherein the resin member extends on the periphery of the LED module and the surface of the resin member of an extending portion is provided with the light reflectivity.
